(19) United States
(12) Patent Application Publication
(10) Pub. No.: US 2007/0162302 A1
(43) Pub. Date: Jul. 12, 2007

(54) Cosign feature of medical note-taking software

(76) Inventor: Greg Goodrich, West Des Moines, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/602,142

(22) Filed: Nov. 20, 2006

Related U.S. Application Data
(60) Provisional application No. 60/738,634, filed on Nov. 21, 2005.

(51) Int. Cl. G06Q 10/00

(52) U.S. Cl. 705/2

(57) ABSTRACT

Medical note-taking software is used by healthcare professionals to author notes to be used by the software in generating medical documents. The present invention adds cosign functionality. Each healthcare professional user of the software is assigned a level of authority over notes which can be used by the software application for generating medical documents, such as prescriptions, bills, and the like. If the author of a note does not have final signatory authority, before the note is treated as final by the software application, a user with final signatory authority is required to cosign the note.

This application claims priority to U.S. Patent Application Ser. No. 60/738,634, filed Nov. 21, 2005.

### BACKGROUND OF THE INVENTION

1. Field of the Invention

The invention relates generally to a computer software system for generating medical notes and, more specifically, to a computer software system for generating documents which comprise a patient file which uses an object-based interface and a method for linking objects which includes functionality to permit an administrator to require cosigning of medical notes in preselected circumstances.

2. Background of the Art

Providing medical care to patients involves the generation of large quantities of paper which comprise a patient's medical file. Typically, the patient file is created at the first visit of the patient to a treatment facility, such as a doctor's office, a clinic, a hospital, or the like. The file includes the patient's medical history, treatments, referring physician information, insurance information,-current drugs prescribed, test results, diagnoses, X-rays and other image-based information, and notes taken by the healthcare professional to record information regarding the patient conditions, complaints, care instructions and the like. The patient file is updated whenever new information is received, such as upon a subsequent patient visit, the return of laboratory results, correspondence from a consulting physician, and so on. A patient's file will also contain copies of correspondence sent to a physician to which the patient has been referred.

Most healthcare providers still generate notes for patient files by either writing them on forms or in long-hand, or by dictating notes which are then transcribed by non-medical personnel. This process requires significant time by the healthcare provider and/or the cost of the employment of transcribers or a transcription service.

There have been many software systems developed and sold which assist the healthcare provider in generating and maintaining the patient files. One type of system uses voice recognition software to automatically transcribe dictated recording of notes. While such software continues to improve, significant amounts of time must be spent in training the system and, even with much training, the software still makes errors that need to be corrected by human review.

Medical practitioners have highly individualized approaches to their medical practice and hence their preferred form of medical notes and the order and content of those notes is also highly individualized. Medical note generating software that allows the user to customize the software to require medical notes authored by medical practitioners without final signatory authority to be cosigned improve the functionality and flexibility of the software for each user.

### SUMMARY OF THE INVENTION

The invention applies to a computer software system for generating medical documents for a patient medical file. The software system includes a user interface with a plurality of components selected by a healthcare provider for the entry of information to be included in the medical documents. The user interface components include metadata objects that relate to medical objects. The healthcare provider selects from the medical. objects and the software system generates patient data objects that are added to the medical file of the patient. The software system includes a relational database that is used for storing and retrieving the metadata objects, the medical objects and the patient data objects. Each of the three object components are stored in a table structure wherein a first table stores the object and a second table stores a plurality of properties associated with the object.

Medical services are provided by a wide variety of practitioners: physicians, nurses, interns, residents, physician assistants, EMTs, and the like. According to the present invention, users of the software system customize the software by requiring medical notes, under certain circumstances, to be signed by more than one person. Medical notes that are authored by a medical practitioner who, in the view of an administrator of the medical facility, does not have sufficient training, education or experience to have final signatory authority, will not be recognized by the software system as final notes. Accordingly, notes authored by a person without final signatory authority must be cosigned by an authorized person before the note is available to be finalized by the software.

### BRIEF DESCRIPTION OF THE DRAWINGS

FIG. 1 is a dialog box that is used when creating a role for a user, specifically assigning the ability to review and cosign medical notes authored by another.

FIG. 2 is a dialog box that is used to edit or modify a role, specifically the ability to write notes that do not require a co-signature.

FIG. 3 is a dialog box that is launched when a user without final signatory authority attempts to save or digitally sign a note.

FIG. 4 is a sample dialog box that is displayed when a user with cosign authority elects to cosign a note.

### DETAILED DESCRIPTION OF THE PREFERRED EMBODIMENTS

This specification incorporates herein by this reference U.S. patent applications Ser. Nos. 11/040,025 and 60/704,823.

The invention is a part of an object-oriented software application that produces medical documents using an object-based user interface and item/property data-storage. Data storage is set up to store metadata objects, medical objects built on the metadata objects, and patient objects that are the output of the medical objects. A relational database is used to store and retrieve metadata objects, medical objects, and patient data objects. The table structure for the three object components is set up as two tables per object type. The first table stores the object and the second table stores the properties associated with the object.

One function of the software is to generate medical notes taken by a healthcare professional to record information regarding the patient conditions, complaints, care instructions, and the like. Healthcare professionals who author notes represent persons with a wide variety of education, training and experience. In particular circumstances, the administration of the medical or healthcare facility may not judge it appropriate to have all of the healthcare professionals that provide medical services at the facility to have notes that they author entered into the software system unless they have been reviewed and approved by someone with the requisite education, training and/or experience. The software has been adapted so that it permits an administrator of the software to assign authority or “roles” to each of the healthcare professionals with note-authoring authority of the software. The role may provide final signatory authority to the healthcare professional in which case the professional may author and sign the note for further processing by the software, that is made final, without the assistance or authority of another. Alternatively, the role may limit the authority of the professional such that any notes authored by the professional must be cosigned by one having final signatory authority over the note before it can be saved and finally entered into the software system. The software also permits final signatory roles to be limited to certain types of notes. For example, a dermatologist may have final signatory authority over notes dealing with dermatological conditions, but not if the note dealt with, say, a neurological condition.

### EXAMPLE 1

Often times, there is a need for two people to sign a note. Perhaps a resident or student has completed the initial note and the attending doctor must sign off with his/her approval. Or, maybe a clinic may require review of notes signed by nurses (those with signing privileges). To accommodate those needs, the software of the present invention includes cosign functionality. When a note requiring a co-signature is signed by the first user, a billing statement is not available for export at that time. When the second user with final signatory authority cosigns the note, the billing statement will then be available for export.

Cosign Privileges

Two types of privileges may be altered when dealing with cosign functionality; the ability to cosign notes and the ability to write notes that don't require a co-signature.

Ability to Co-Sign Notes

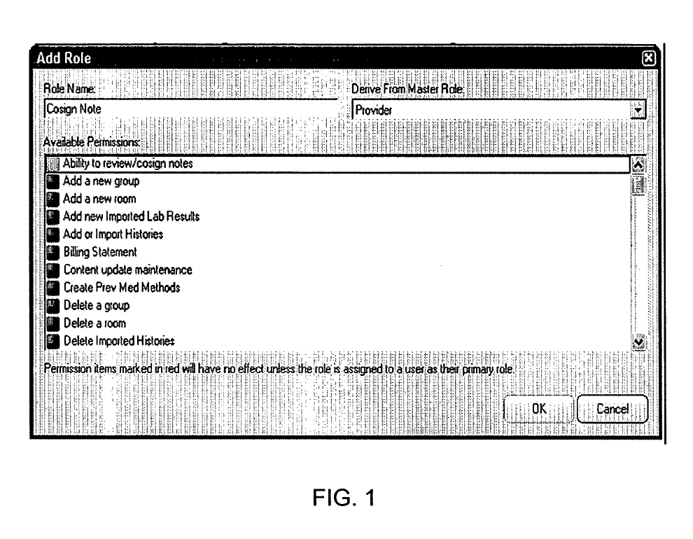

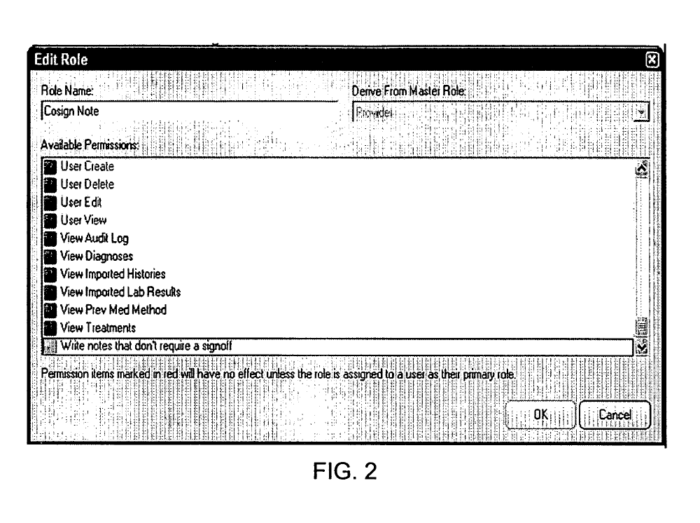

In the security section of the software of the present invention, the Add Role dialog box (FIG. 1) is used by the administrator to create a role for healthcare professionals/users that will be affected by cosign functionality. In the Available Permissions for that role, the administrator either selects or de-selects Ability to review/cosign notes. If Ability to review/cosign notes is selected, any user assigned the role will be able to cosign notes. If it is de-selected, any user assigned the role will not be able to cosign notes. When finished, press OK in the Edit Role dialog (FIG. 2). Pressing Cancel closes the dialog without saving any changes that may have been made.

Ability to Write Notes That Do Not Require a Co-Sgnature

In the security section of the software, an administrator can create a role for each of the users that will be affected by cosign functionality. In the Available Permissions for that role, either the administrator either selects or deselects Write notes that don't require a signoff. If Write notes that don't require a signoff is selected, any user assigned the role will be able to write notes without requiring a co-signature. If it is deselected, any user assigned the role will have to have their notes cosigned. When finished, the administrator presses OK in the Edit Role dialog. Pressing Cancel closes the dialog without saving any changes that may have been made.

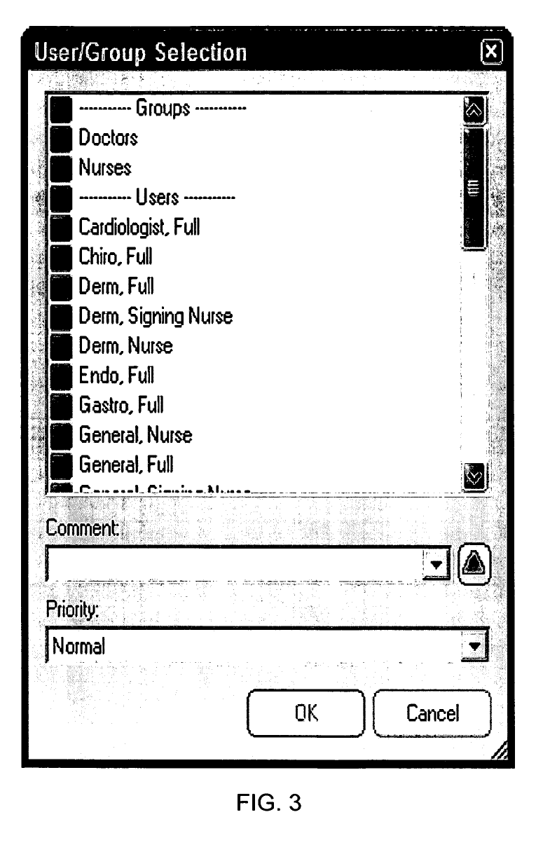

When a user who is required to have a co-signature on his or her notes tries to save or digitally sign a note, that user will be prompted to assign the note to a group or user (or multiples there of). Those selections will be made in the User/Group Selection dialog box (FIG. 3) that is automatically launched when the Save icon or the Digitally sign icon is clicked. The user selects the appropriate group and/or user by clicking the box prior to their listing. When finished, the user presses OK. Pressing Cancel will return you to the note without assigning the note or saving the note.

Cosign a Note

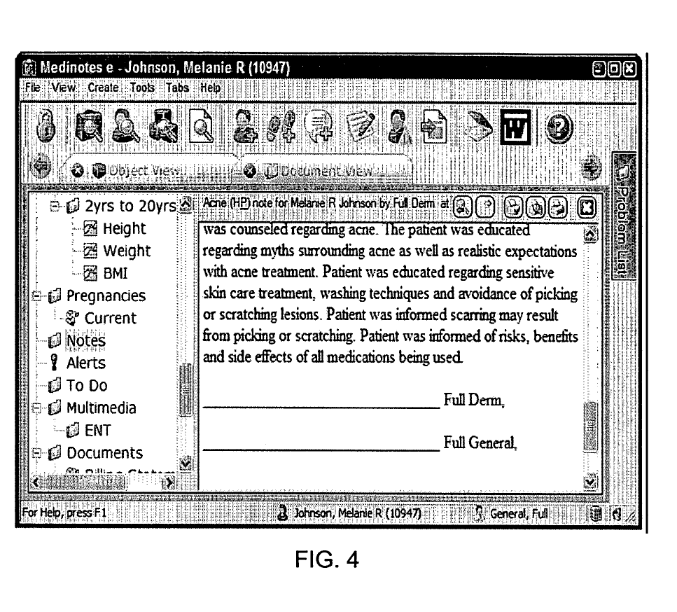

When a note requires a co-signature and the logged in user has the security clearance to do so, a Co-sign icon will appear prior to the name of the note in the Notes category on the patient folder (FIG. 4). The user clicks the note he or she wishes to cosign to highlight it. In the note panel toolbar, the user clicks the Co-sign icon or right-clicks and selects Co-sign Note from the subsequent pop-up list. If the author/originator of the note happens to be of a different discipline, a warning message is displayed. The user presses OK in this pop-up warning to continue the cosign process. The user will enter the note itself, and make any necessary changes and then save the note (select Save and Close, Digitally sign or Hold and Close). Two signature lines will be displayed at the bottom of the saved note.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. An administrator-controlled software application for generating documents including notes authored by a user, comprising:
(a) an administrator interface for assigning a level of signatory authority to a user;
(b) controls for preventing a note authored by a user below a preselected signatory authority level from being recognized by the software application as final; and
(c) a user interface for enabling a user having at least the preselected signatory authority level to sign the note whereupon it is recognized by the software as final.

2. A software application as defined in claim 1, wherein the documents are medical documents.

3. A software application as defined in claim 2, wherein the user is a health practitioner.
